(19) United States
(12) Patent Application Publication
(10) Pub. No.: US 2007/0016477 A1
(43) Pub. Date: Jan. 18, 2007

(54) Online advertising method and online advertising system

(76) Inventors: Ra Young Yang, Seoul (KR); Mi Jeong Choi, Seoul (KR); Woo Sung Lee, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/479,362

(22) Filed: Jun. 30, 2006

Related U.S. Application Data
(63) Continuation of application No. PCT/KR04/03498, filed on Dec. 29, 2004.

(30) Foreign Application Priority Data
Jan. 2, 2004 (KR) 10-2004-0000109

(51) Int. Cl. G06Q 30/00

(52) U.S. Cl. 705/14

(57) ABSTRACT

The present invention relates to an online advertising method and an online advertising system, and more particularly, relates to an online advertising method and an online advertising system using a knowledge providing service system which enables knowledge to be provided through questions and answers between users.

### CROSS-REFERENCE TO RELATED APPLICATIONS

This application is a continuation of International Patent Application No. PCT/KR2004/003498, filed on Dec. 29, 2004, which claims priority to Korean Patent Application No. 10-2004-0000109, filed on Jan. 2, 2004, each of which is incorporated herein by reference.

### BACKGROUND OF THE INVENTION

1. Field of the Invention

The present invention relates to an online advertising method and an online advertising system, and more particularly, relates to an online advertising method and an online advertising system using a knowledge providing service system which enables knowledge to be provided through questions and answers between users.

2. Description of the Related Art

Advertising goods or services by using a network, especially the Internet, becomes our daily activities. Together with this, Internet advertising services that enable advertisements with respect to goods or services on a web site such as a portal site and the like, and that charge a distributor of the goods or services predetermined fees, are performed in a variety of methods.

One of Internet advertising service methods according to the prior art is to allow a banner advertisement on the web site. This method enables a banner consisting of advertising messages or advertising images to be displayed on a predetermined location of the web page, and adopts a method of charging the distributor based on the number of expressions of the banner, the number of clicks of the banner by a user, and the like. These days, the image data are generated into a type of Animated GIF or flash, or generated by using a program language such as java and the like. Thus, it is general to adopt a method of using a banner comprising dynamic images.

In addition, another Internet advertising service method according to the prior art is to allow an inserting advertisement. This method transmits advertisement data to a user terminal while a predetermined web page is loading thereto at the user's request, thereby enabling the advertisement data to be displayed on the user's terminal. Moreover, this method adopts a method of charging the distributor based on the number of transmissions of the advertisement data. In many cases, this method enables the advertisement data to be displayed by using a front surface of indicator of user terminal while the web page is loading. Therefore, there is an advantage that it is highly possible to obtain the user's attention. On the other hand, there is a disadvantage that it is possible to offend the user because an advertisement expression is compulsory and loading of the web page is delayed until transmission of the advertisement data is completed.

Furthermore, another Internet advertising service method according to the prior art is to allow a keyword advertisement. In case that a user inputs a predetermined keyword to use a search service, this method provides a list of search results with respect to the keyword, and puts the web page of a distributor who has paid fees in a higher rank of the search result list. This method adopts a method of charging the distributor based on the number of expressions of the search results, the number of accesses to the web page, and the like.

Besides the aforementioned Internet advertising service methods, there are being used a variety of Internet advertising service methods. Moreover, there are being conceived a variety of Internet advertising service methods in order to enhance both advertisement effects and advertisement orders from advertisers.

### SUMMARY

An object of the present invention is to provide an online advertising method and an online advertising system that may be used in a knowledge providing service system. Namely, an object of the present invention is to provide the online advertising method and the online advertising system which can include and provide advertisement data in knowledge data that the knowledge providing service provides users. Knowledge data including the advertisement data is knowledge advertisement data.

Furthermore, another object of the present invention is to provide the online advertising method and the online advertising system which enable a targeting advertisement by providing a user with knowledge advertisement data including a keyword input by the user.

Furthermore, another object of the present invention is to provide the online advertising method and the online advertising system, which enable a targeting advertisement by providing a user with knowledge advertisement data through a category search method, i.e. by providing a user with knowledge advertisement data associated with a category corresponding to a field in which the user is interested.

Furthermore, another object of the present invention is to provide the online advertising method and the online advertising system, which enable a fee to be charged once or more during a variety of procedures while charging an advertiser in a procedure of registering knowledge advertisement data including the advertisement data, i.e. enabling the advertiser to be charged respectively in a procedure in which the knowledge advertisement data is expressed as search results, a procedure in which the knowledge advertisement data is selected by the user and provided for the user, a procedure in which the user gets access to a predetermined web page by using a link included in the knowledge advertisement data, or a procedure in which the user purchases predetermined goods by getting access to the web page.

Furthermore, another object of the present invention is to provide the online advertising method and the online advertising system, which enable an advertiser to select various levels of advertisement data display methods and enable the advertiser to be charged differently based on the levels.

In order to achieve the above objects, an online advertising method according to the present invention comprises the steps of: maintaining knowledge data in a predetermined knowledge database, wherein the knowledge data includes question data and answer data associated therewith; registering and maintaining at least one advertisement record in the predetermined knowledge advertisement database, wherein the advertisement record comprises at least one selected from a group of consisting of knowledge advertisement data including question data, answer data, or advertisement data, an advertiser, and data of the number of expressions associated with the knowledge advertisement data; receiving a keyword from a user through a communication network; searching for knowledge data including the keyword by referring to the knowledge database; searching for knowledge advertisement data including the keyword by referring to the knowledge advertisement database; generating a search result list with respect to the searched knowledge data or the searched knowledge advertisement data, and providing the user with the generated search result list; updating and recording data of the number of expressions associated with the searched knowledge advertisement data, in the advertisement record; and controlling the advertiser to be charged by using the data of the number of expressions.

Furthermore, the present invention provides an online advertising method, comprising the steps of: registering and maintaining at least one advertisement record in the predetermined knowledge advertisement database, wherein the advertisement record comprises at least one selected from a group of consisting of knowledge advertisement data including question data, answer data, or advertisement data, an advertiser, and data of the number of expressions associated with the knowledge advertisement data, and the advertisement record is registered by categories; receiving a selection of a category from a user; searching for an advertisement record corresponding to the selected category and searching for knowledge advertisement data comprised therein, by referring to the knowledge advertisement database; generating a search result list with respect to the searched knowledge advertisement data, and providing the user with the generated search result list; updating and recording data of the number of expressions associated with the searched knowledge advertisement data, in the advertisement record; and controlling the advertiser to be charged by using the data of the number of expressions.

Furthermore, according to one aspect of the present invention, said step of registering and maintaining at least one advertisement record in the knowledge advertisement database comprises the steps of: giving authority for registration of knowledge advertisement data associated with question data including a predetermined keyword, to an advertiser; controlling fees with respect to the authority for registration to be charged the advertiser; with respect to question data that has been registered in the knowledge database and includes the keyword, receiving advertisement data and answer data including the keyword, from the advertiser; generating knowledge advertisement data by using the question data, the answer data, and the advertisement data; and registering and maintaining the generated knowledge advertisement data or an advertiser identifier for identifying the advertiser, in the knowledge advertisement database.

Furthermore, according to another aspect of the present invention, the advertisement record further includes data of the number of selections associated with the knowledge advertisement data; and the online advertising method further comprises the steps of: receiving a selection of search results with respect to knowledge advertisement data among the search result list, from the user; providing the user with knowledge advertisement data associated with the search results, by displaying the same; updating and recording the data of the number of selections in the advertisement data; and controlling fees with respect to providing of the knowledge advertisement data, to be charged the advertiser, by using data of the number of selections.

Furthermore, according to another aspect of the present invention, the advertisement record further includes data of the number of link selections associated with the knowledge advertisement data, and the advertisement data includes data for providing a link to a predetermined web page; and the online advertising method further comprises the steps of: receiving a selection of search results with respect to knowledge advertisement data among the search result list, from the user; providing the user with knowledge advertisement data associated with the search results, by displaying the same; receiving a selection of a link to the web page from the user, and relaying the user's terminal to be accessed to the web page by using the data; updating and recording the data of the number of link selections, in the advertisement record; and controlling fees with respect to providing of the link to be charged the advertiser, by using the data of the number of link selections.

### BRIEF DESCRIPTION OF THE DRAWINGS

FIG. 1 is a drawing illustrating a network connection of a knowledge providing service system in which an online advertising method according to each embodiment of the present invention may be used.

FIG. 2 is a drawing illustrating one example of knowledge data that the knowledge providing service system provides users through a predetermined web page.

FIGS. 3a and 3b is a flowchart illustrating an online advertising method according to one embodiment of the present invention.

FIG. 4 is a drawing illustrating a process of performing steps of maintaining a knowledge advertisement database according to one embodiment of the present invention, in more detail.

FIG. 5a is a drawing illustrating one example of an advertisement record maintained in the knowledge advertisement database, in one embodiment of the present invention.

FIG. 5b is a drawing illustrating one example of knowledge advertisement data included in the advertisement record.

FIG. 6 is a drawing illustrating one example of a search result list that is provided for a user, in case that the user inputs a keyword of ‘notebook’, in one embodiment of the present invention.

FIG. 7 is a drawing illustrating one example of a first fee database, in one embodiment of the present invention.

FIG. 8 is a drawing illustrating one example of knowledge advertisement data that is provided for a user, in one embodiment of the present invention.

FIGS. 9a and 9b are drawings for explaining a process in which a user selects knowledge advertisement data by category searching method, in an online advertising method according to one embodiment of the present invention.

FIG. 10 is a block diagram illustrating an online advertising system according to another embodiment of the present invention.

FIG. 11 is an internal block diagram of a general-purpose computer which may be adopted in performing an online advertising method according to the present invention.

### DETAILED DESCRIPTION

Hereinafter, the present invention will be in detail described with reference to the accompanying drawings.

The terms of ‘knowledge advertisement data’ used in the present specification means knowledge data including advertisement data. Moreover, ‘a web page for knowledge advertisement’ means a web page on which predetermined advertisement is displayed.

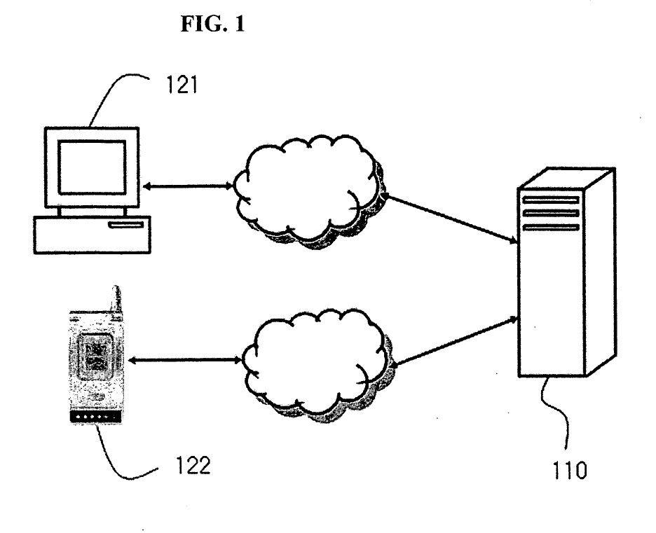

FIG. 1 is a drawing illustrating a network connection of a knowledge providing service system in which an online advertising method according to each embodiment of the present invention may be used. In the meantime, the knowledge providing service system introduced in the present specification is for an example. Therefore, the present invention is adaptable to all sorts of knowledge providing service systems that perform services of providing users with knowledge formed through questions and answers therebetween.

A knowledge providing service system 110 receives question data from a user 121, and records and maintains the received question data in a predetermined knowledge database. In addition, the knowledge providing service system 110 provides users with the knowledge data by displaying the same on a predetermined web page. The user 122 who has been provided with the question data, may input answer data with respect to the question data, in the knowledge providing service system 110. The answer data is displayed on the web page in association with the question data. The knowledge providing service system 110 records the answer data in the knowledge database in association with the question data, and maintains both the question data and the answer data as knowledge data.

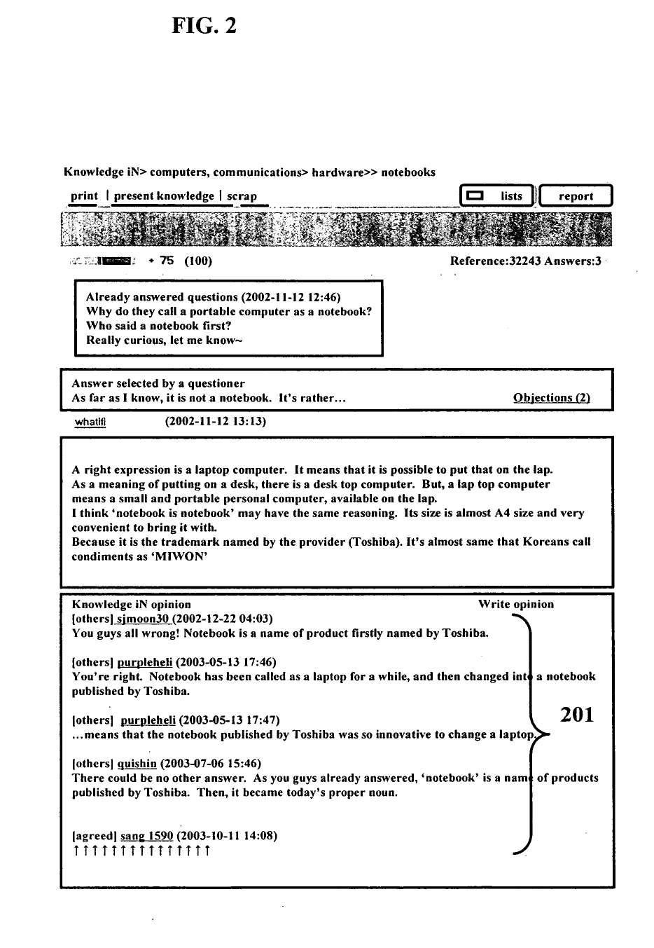

Accordingly, the user 121 may be provided with an answer to the user's own question and other users who have not input the question data directly may be provided with variety of knowledge through the web page. FIG. 2 is a drawing illustrating one example of knowledge data that the knowledge providing service system 110 provides users through the web page. The knowledge data includes question data and answer data. The knowledge providing service system 110 may display opinion data that a questioner (a user who has input question data), an answerer (a user who has input answer data), or other users besides the questioner and the answer have input, as indicated by a drawing symbol 201, in accordance with a type of services. In the meantime, the knowledge data may be provided by various methods, besides the method of displaying the knowledge data on the web page, such as a method of providing the user with the knowledge data by wirelessly transmitting the same through a wireless terminal, etc.

In addition, the knowledge providing service system 110 provides a search service, enabling users 121 and 122 to search for a variety of knowledge data maintained and accumulated in the knowledge database. As the time passes, an amount of knowledge data accumulated in the knowledge database has no choice but to be enlarged. Thus, it is preferable to provide a search service so that users may be provided with knowledge data they want.

The search service may be performed by keyword searching method or category searching method. As for example, the present embodiment describes that the knowledge providing service system 110 provides the search service by using both the keyword searching method and the category searching method. An online advertising method according to the present embodiment may be performed by an online advertising system that is embedded in the knowledge providing service system 110, or interoperates therewith 110.

In addition, the online advertising system includes a predetermined knowledge database or a predetermined knowledge advertisement database. The knowledge database or the knowledge advertisement database may be embodied into the same database. Moreover, the knowledge advertisement database further includes a variety of fields with respect to information associated with an advertiser, information necessary for charging the advertiser, and the like, which will be described later. Therefore, according to another embodiment of the present invention, the knowledge database and the knowledge advertisement database are embodied into separate databases for convenience of managements.

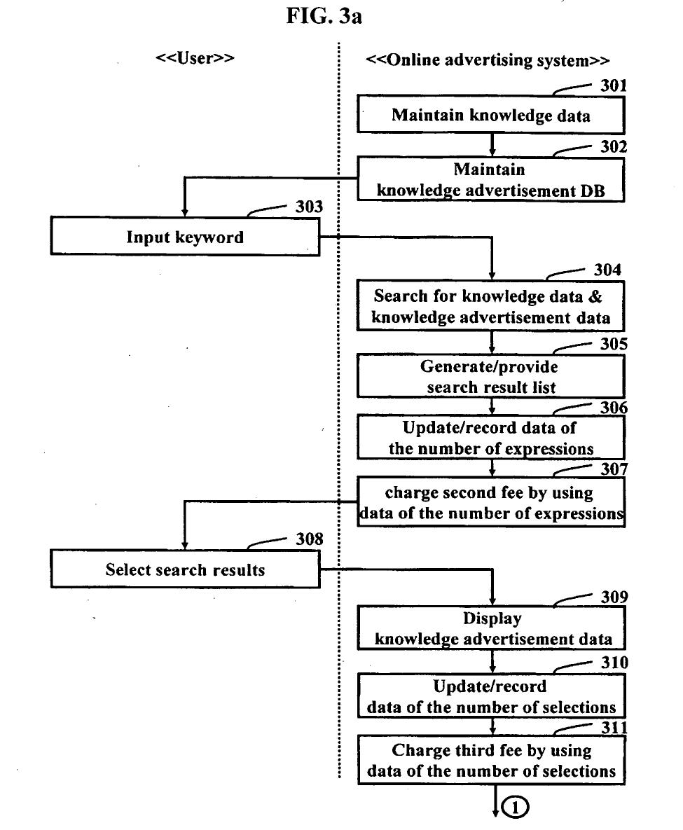

FIG. 3 is a flowchart illustrating the online advertising method according to the present embodiment.

In step 301, knowledge data is maintained in the knowledge database. The knowledge data includes question data and answer data associated therewith. The knowledge data may be accumulated during a process in which the knowledge providing service system 110 provides the aforementioned service.

In step 302, at least one advertisement record is registered and maintained in the knowledge advertisement database. The advertisement record includes knowledge advertisement data, an advertiser identifier, data of the number of expression associated with the knowledge advertiser data, data of the number of selections associated therewith, data of the number of purchase of goods associated therewith, or data with respect to a display method. The knowledge advertisement data includes question data, answer data, advertisement data, or opinion data.

The advertisement data may include data for providing a link to a web page associated with the advertiser, a bulletin board for inquiries or a bulletin board for post-purchases, advertisement copy data or image data with respect to an advertisement object.

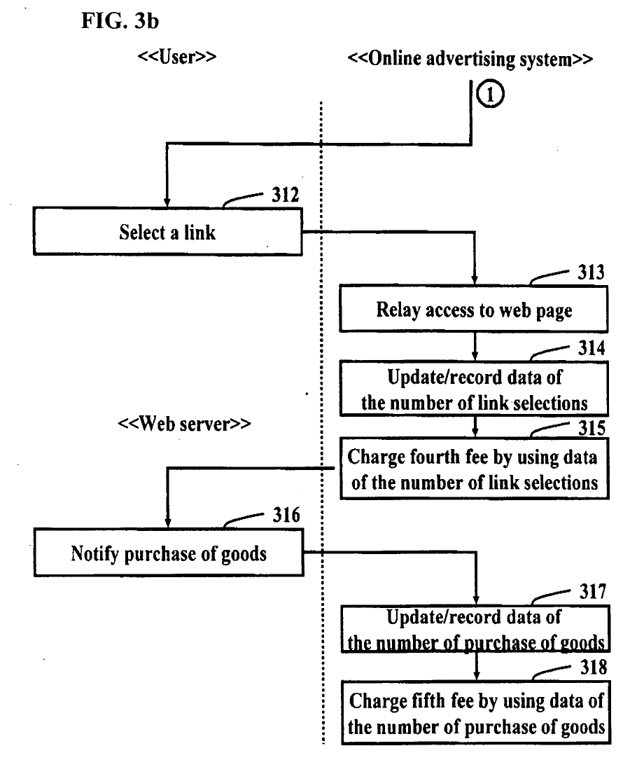

FIG. 4 is a drawing illustrating a process for performing the step 302 according to one embodiment of the present invention, in more detail. In step 401, the online advertising system sells authority for registration associated with a keyword. The authority for registration is authority enabling question data including the keyword or knowledge data including answer data to be registered in the knowledge advertisement data. The authority for registration may be auctioned off. The online advertising system may further comprise an online auction system for advertisers who want to purchase the authority for registration. In case that the authority for registration is sold through auction, a first fee with respect thereto is determined through auction. According to embodiments, the authority for registration may be given to the advertiser during a certain period such as 30 days, etc, or during a period when data of the number of selections becomes a predetermined value.

Furthermore, according to another embodiment of the present invention, the online advertising system may sell the authority for registration by unit of keyword group having the same or similar meaning, not by one keyword.

In step 402, the online advertising system controls the first fee to be charged an advertiser who has purchased the authority for registration (a first charge).

In case that question data including the keyword is input from a user, the online advertising system receives answer data with respect to the question data and advertisement data from an advertiser who has been given authority for registration associated with the keyword, in step 403. For example, in case that the keyword is ‘notebook’ and question data received from the user includes a keyword of ‘notebook’ such as ‘which notebook is good?’, ‘is it possible to turn off only monitor?’, or the like, the online advertising system notifies the advertiser of the event that the a question including the keyword has been received. The advertiser generates answer data that is appropriate for question data including the keyword, and inputs the generated answer data into the online advertising system. In addition, the advertiser further inputs advertisement data associated with the question data and the answer data. The advertisement data includes advertisement copy data or image data with respect to an advertisement object.

In step 404, the online advertising system generates knowledge advertisement data including the question data, the answer data, and the advertisement data. In step 405, the online advertising system generates an advertisement record including the generated knowledge advertisement data, and registers and maintains the generated advertisement record in the knowledge advertisement database. The advertisement record further an advertiser identifier for identifying the advertiser, as aforementioned, data necessary for charging a second fee, a third fee, etc, and the like.

In the meantime, in case that the authority for registration is sold by unit of keyword group, even in case that a question with a keyword included in the keyword group is received from the user, the advertisement record may be registered through the aforementioned procedures.

Furthermore, as described later, in case that the online advertising system further provides a bulletin board for inquiries or a bulletin board for post-purchases, the online advertising system further includes data for providing a link to the bulletin board for inquiries or to the bulletin board for post-purchases, in the advertisement data. That is, the online advertising system may use advertisement data received from the advertiser, as it is. In addition, the online advertising system may process the received advertisement data by a predetermined method or generate the advertisement record by adding separate advertising data.

Furthermore, in case that URL information for a link to a web page associated with the advertiser is further received therefrom, the online advertising system generates the advertisement record by further including data for providing a link to the URL in the advertisement data.

Like above, advertisement data may include data for providing a variety of services (e.g., a service for providing users with a bulletin board for inquiries). The online advertising system may control an additional fee besides the first fee to be charged the advertiser, based on a kind of the service or providing thereof.

Furthermore, according to another embodiment of the present invention, the online advertising system may also receive question data from the advertiser, regardless of whether a user has input question data including the keyword. For example, the advertiser may prepare question data such as ‘when you buy a notebook’ and input the prepared question data in the online advertising system. That is, the online advertising system further receives question data from the advertiser, in step 403, and generates knowledge advertisement data by using answer data, advertisement data and question data received from the advertiser, in step 404.

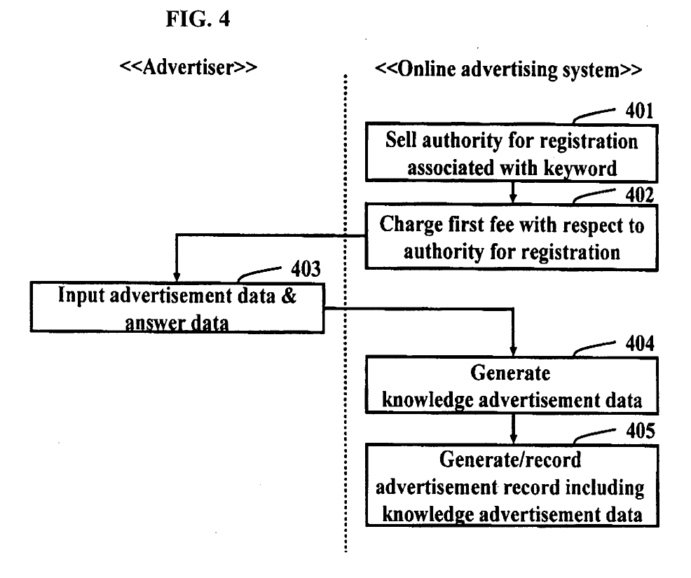

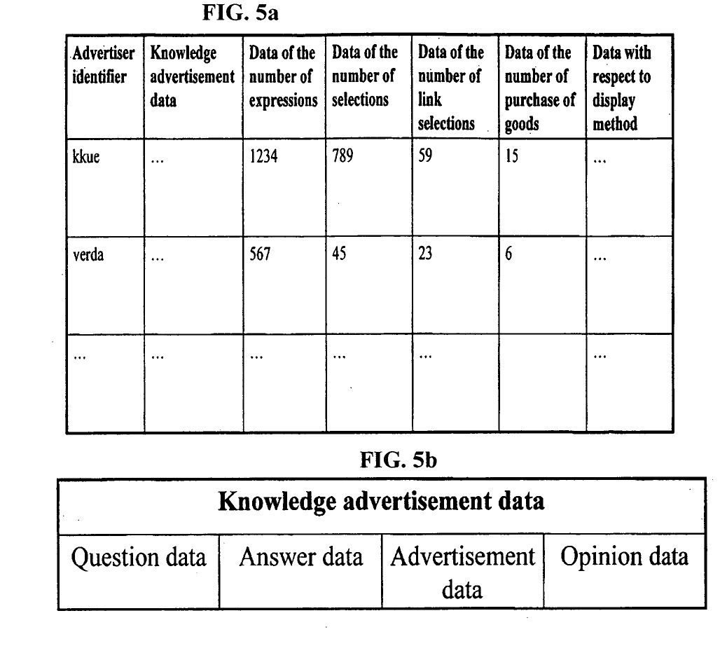

Through the aforementioned process, advertisement records are registered and maintained in the knowledge advertisement database, in the step 302. FIG. 5a is a drawing illustrating one example of advertisement records maintained in the knowledge advertisement database. FIG. 5b is a drawing illustrating one example of knowledge advertisement data included in the advertisement record.

The online advertising system receives a keyword from a user, in step 303. The online advertising system searches for knowledge data including the keyword by referring to the knowledge database, and searches for knowledge advertisement data including the keyword by referring to the knowledge advertisement database (step 304).

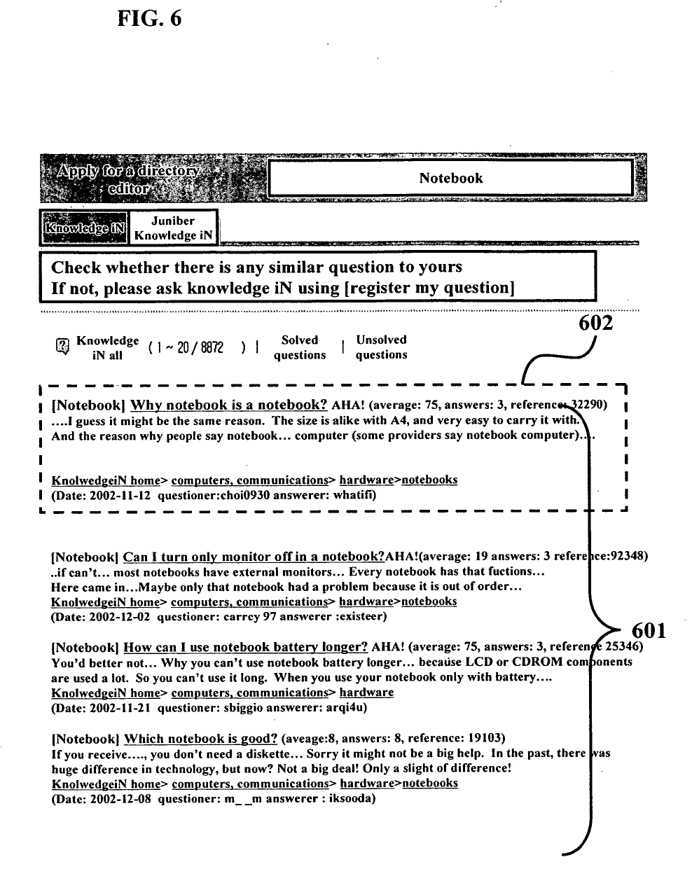

In step 305, the online advertising system generates a search result list with respect to the searched knowledge data or the searched knowledge advertisement data, and provides the user with the generated search result list. A drawing symbol 601 of FIG. 6 indicates one example of search result lists provided for a user, in case that the user inputs a keyword of ‘notebook’.

In step 306, the online advertising system updates and records data of the number of expressions associated with the searched knowledge advertisement data. That is, in case that search results with respect to the knowledge advertisement data are included in the search result list and expressed as indicated by 601, the online advertising system updates the data of the number of expressions.

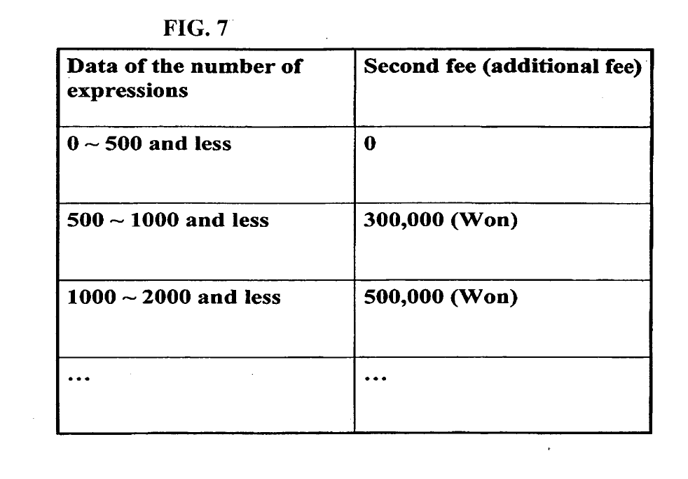

In step 307, the online advertising system controls a second fee associated with expression of search results with respect to the knowledge advertisement data, to be charged by using the data of the number of expressions (a second charge). According to embodiments, the online advertising system may maintain data of the number of expressions and the second fee associated therewith, in a predetermined first fee database and may determine the second fee by referring to the first fee database. FIG. 7 is a drawing illustrating one example of the first fee database, in the present embodiment. Referring to FIG. 7, in case of charging the second fee, the online advertising system does not charge the second fee in case that data of the number of expressions is below 500, and charges the second fee which is added by certain number in case that data of the number of expressions exceeds 500.

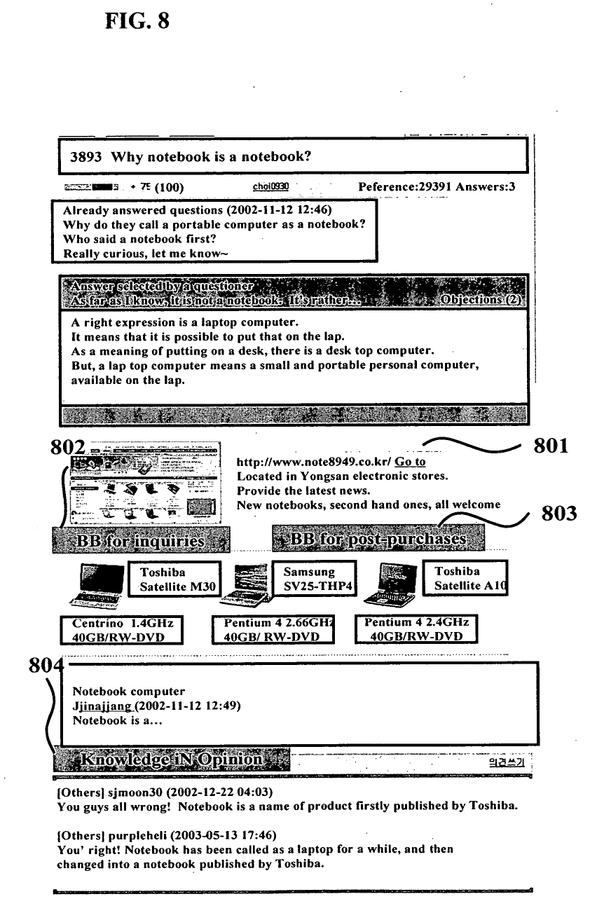

In step 308, the online advertising system receives a selection of search results among the search result list 601, from the user. For example, in case that the user selects search results as indicated by a drawing symbol 602 of FIG. 6, the online advertising system provides the user with knowledge advertisement data associated with the search results, by displaying the same, in step 309. FIG. 8 is a drawing illustrating one example of knowledge advertisement data provided for the user. A drawing symbol 801 indicates where the online advertising system provides a link to a web page associated with the advertiser (e.g., a web page for selling goods). Drawing symbols 802 and 803 are buttons for providing a bulletin board for inquiries and a bulletin board for post-purchases respectively. In addition, it is also possible to provide the user with images of goods by using image data included in advertisement data, as illustrated in FIG. 8.

As aforementioned, in case that the knowledge advertisement data is provided for the user, the online advertising system updates and records the data of the number of selections in the advertisement record, in step 310. In step 311, the online advertising system controls a third fee with respect to providing of the knowledge advertisement data to be charged the advertiser, by using the data of the number of selections.

A user who has been provided with knowledge advertisement data as illustrated in FIG. 8, may select a link indicated by the drawing symbol 801, 802, or 803, in step 312, so as to move to a web page associated with the advertiser, the bulletin board for inquiries, or the bulletin board for post-purchases. In case that a selection of the link is received from the user, the online advertising system relays the user (more particularly, the user's terminal) to be accessed to a web page corresponding to the selected link, in step 313.

The online advertising system updates and records the data of the number of link selections in the advertisement record, in step 314, and controls a fourth fee with respect to providing of the link to be charged the advertiser by using the data of the number of link selections (a fourth charge).

A user who has got access to a web page associated with the advertiser through the aforementioned process, may purchase goods according to a predetermined procedure demanded by the web page. In case that the user accesses a web page associated with the advertiser, through a web page providing the knowledge advertisement data (hereinafter, the web page is ‘a web page for knowledge advertisement’), and purchases goods on the web page, a web server providing the web page notifies the online advertising system of the fact, in step 316 and the online advertising system updates and records the data of the number of purchase of goods in the advertisement record, in step 317.

In step 318, the online advertising system controls a fifth fee with respect to the purchase of goods to be charged the advertiser by using the data of the number of purchase of goods (a fifth charge).

In the meantime, in order to determine the third to the fifth fees, the online advertising system may further include a fee database that is similar to the first fee database as illustrated in FIG. 7. Namely, the online advertising system may maintain fee data by data of the number of selections, fee data by data of the number of link selections, fee data by the number of purchase of goods, and the like, in the fee database, and make the advertiser pay a predetermined additional fee, whenever each data value exceeds a predetermined value. However, a method of determining fees like above is for an example. The scope of the present invention may include all the configuration of computing the data of the number of expressions, the data of the number of selections, the data of the number of link selections, or the data of the number of purchase of goods, and charging the advertiser by using each of data.

Furthermore, according to another embodiment of the present invention, the online advertising system may include a plurality of different methods of displaying knowledge advertisement data, and charge the advertiser differently based on each method. The online advertising system notifies the advertiser of the fact that ‘variety of display methods may be adopted and fees will be charged differently based on each method’, and receives a selection of display methods from the advertiser. The online advertising system includes and records data with respect to the selected display method, in the advertisement record. The process like above may be performed in a procedure of generating an advertisement record in step 405, and even after the advertisement record is generated, may be performed in case that a selection of display methods is received from the advertiser.

The online advertising system may maintain fee data based on display methods, in a predetermined second fee database, and by referring to the second fee database, determine fees differently based on each method, according to the advertiser's selection.

For example, the display method is related to a location of search results associated with knowledge advertisement data. Among search result lists with respect to a keyword received from the user, the online advertising system may allow search results with respect to the knowledge advertisement data to be placed in a higher rank of the search result lists.

As for another example, the display method is related to search results with respect to knowledge advertisement data or a display type thereof. In case that search results associated with knowledge advertisement data, among the search result lists of step 305, are displayed or in case that knowledge advertisement data selected by a user in step 309 is displayed, the online advertising system may enable the knowledge advertisement data or search results with respect thereto to be displayed in a different type (different font size, different color or different icon) from other knowledge advertisement data or other search results.

Furthermore, according to another embodiment of the present invention, the advertisement record further includes opinion data. A user who has been provided with knowledge advertisement data in step 309, may input opinion data into the online advertising system, so as to express one's opinion with respect to question data, answer data or advertisement data included in the knowledge advertisement data.

The online advertising system that has received the opinion data, includes the opinion data in the knowledge advertisement data, and records and maintains the same in the advertisement record. The opinion data is one of the knowledge advertisement data as indicated by a drawing symbol 804, and displayed in association with question data, answer data, or advertisement data.

Meanwhile, according to another embodiment of the present invention, the online advertising system gives a right of deleting the opinion data to the advertiser. That is, predetermined opinion data selected by the advertiser may be deleted from the advertisement record at the advertiser's request. In case that opinion data including a negative opinion with respect to goods sold by the advertiser is displayed, this may reduce advertisement effects. Therefore, the advertiser is allowed to delete this opinion data.

Furthermore, according to another embodiment of the present invention, in case that the advertiser inputs new answer data or new advertisement data, the online advertising system updates and records an advertisement record maintained in the knowledge advertisement database, by using the new answer data or the new advertisement data. According to the configuration like above, even after knowledge advertisement data is generated and registered, the advertiser may give an answer or put an advertisement, which is considered to be more suitable for the advertisement, by updating the knowledge advertisement data.

Furthermore, according to another embodiment of the present invention, the online advertising system may further provide a user with a messaging service which transmits a message including simple text data, so as to enable communications between the advertiser and the user provided with the knowledge advertisement data. Moreover, the online advertising system may further provide a user with a messaging service for making real-time communications.

Furthermore, in case that a user purchases goods by getting access to a web page associated with the advertiser through the web page for knowledge advertisement, the online advertising system may provide the user with an additional service such as providing of mileages, indifferently from the advertiser.

Furthermore, the online advertising system interoperates a self-login procedure with a login procedure of the web server that manages a web page associated with the advertiser. Therefore, in case that a user gets access to a web page associated with the advertiser from the web page for knowledge advertisement, an additional login procedure may be unnecessary.

Furthermore, each of the aforementioned embodiments mainly describes the event that a user includes the knowledge advertisement data in accordance with a keyword searching method. However, knowledge advertisement data may be provided for a user by category searching method. At this time, an advertisement record including the knowledge advertisement data is registered and maintained by categories. In case that a predetermined category is selected from a user, the online advertising system searches for an advertisement record corresponding to the selected category, generates a search result list with respect to knowledge advertisement data included in the advertisement record, and provides the user with the generated search result list.

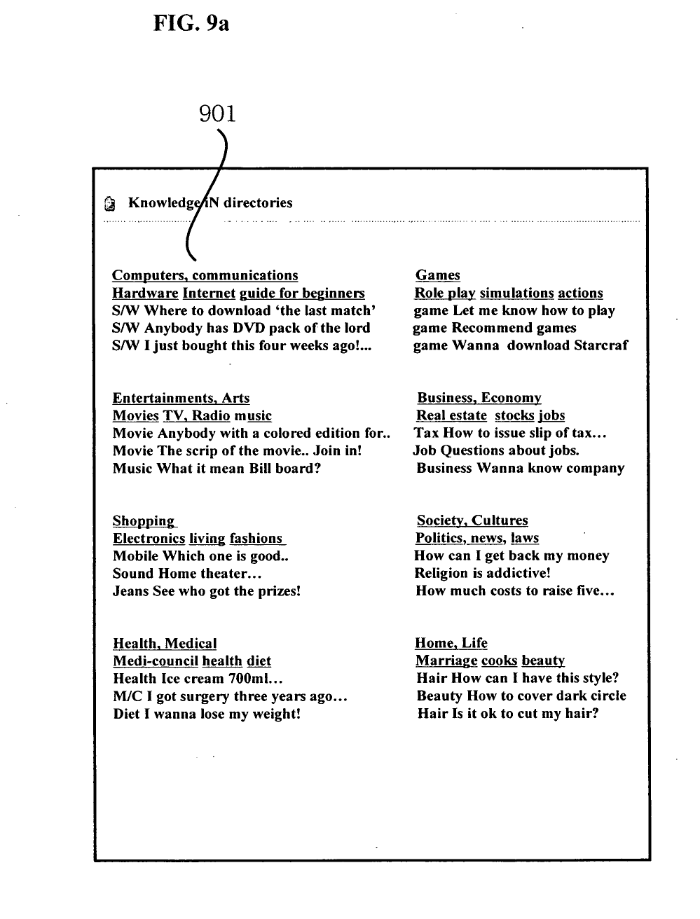

FIG. 9 is a drawing for explaining a process in which the user inputs a selection of categories by category searching method. The online advertising system provides an interface enabling the user to select a category, as illustrated in FIG. 9a. The terms of ‘directory’ used in FIG. 9 is used as the same meaning with a ‘category’.

A drawing symbol 901 of FIG. 9a means the highest ranking category. In case that the user selects a category of ‘computer, communications’, a screen as illustrated in FIG. 9b is provided for the user. At this time, the user can select one's desired category in such a way that the user selects one category among lower categories of ‘computer, communications’ category 902. Like above, in case that the user searches for knowledge advertisement data through a category searching method, a category may have one or more depths based on inclusive relations thereof, so that the user may select a predetermined category easily.

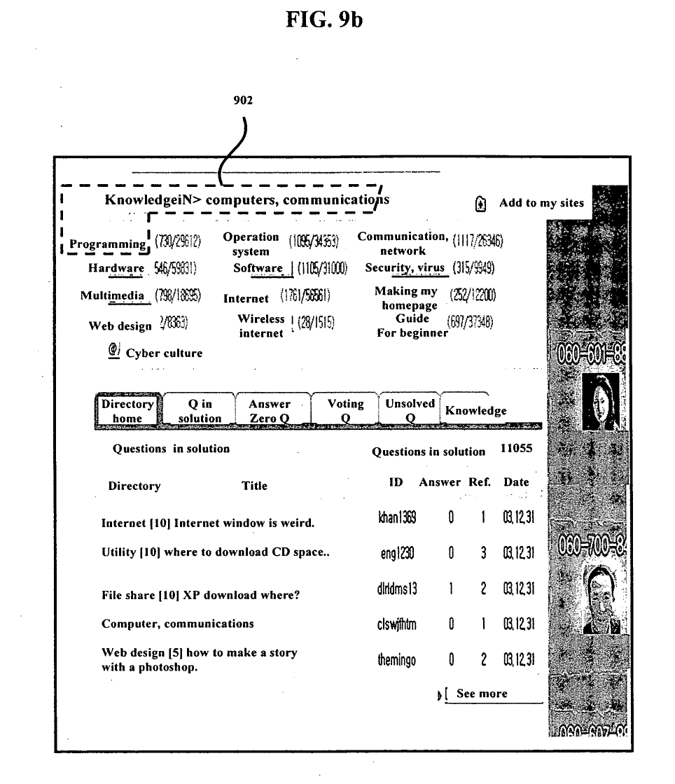

Hereinafter, an online advertising system according to another embodiment of the present invention will be described. FIG. 10 is a block diagram illustrating the online advertising system according the present embodiment. An online advertising system 1000 is a system embedded in the knowledge providing service system 110 or interoperating therewith 110.

The online advertising system 1000 comprises a knowledge database 1001, a knowledge advertisement database 1002, an input unit 1003, a search unit 1004, an output unit 1005, an advertisement record management unit 1006 and a fee computing unit 1007.

The knowledge database 1001 maintains knowledge data registered by the knowledge providing service system 110. The knowledge data includes question data and answer data associated therewith.

The knowledge advertisement database 1002 maintains at least one advertisement record. The advertisement record includes knowledge advertisement data, an advertiser identifier, data of the number of expression associated with the knowledge advertisement data, data of the number of selections associated therewith, data of the number of link selections associated therewith, or data of the number of purchase of goods associated therewith. At this time, the knowledge advertisement data includes question data, answer data, advertisement data, or opinion data. The advertisement data may have a structure of database as illustrated in FIG. 5. In addition, the knowledge database 1001 and the knowledge advertisement database 1002 may be embodied into one database means.

The online advertising system 1000 may sell authority for registering an advertisement record including knowledge advertisement data, wherein the authority may be sold in association with a predetermined keyword or a group of keywords. Selling price on the authority (a first fee) may be determined by unit of registration period of the advertisement record, unit of the number of expressions of search results with respect to the knowledge advertisement data, or unit of the number that the knowledge advertisement data is selected from a user.

An advertiser having the authority inputs answer data with respect to predetermined question data, advertisement data, or opinion data. The online advertising system 1000 generates knowledge advertisement data from the question data, the answer data, the advertisement data, or the opinion data, and registers and maintains the generated knowledge advertisement data in the knowledge advertisement database 1002. The question data may be input form a user or the advertiser. The knowledge advertisement data includes the predetermined keyword or a keyword included in the keyword group. The online advertising system 1000 may generate the advertisement record by processing the advertisement data input from the advertiser through a predetermined method.

The input unit 1003 receives a keyword from a user through a communication network.

The search unit 1004 searches for knowledge data including the keyword by referring to the knowledge database 1001, and searches for knowledge advertisement data including the keyword by referring to the knowledge advertisement database 1002.

The output unit 1005 generates a search result list with respect to the searched knowledge data or the searched knowledge advertisement data, and provides the user with the generated search result list.

The advertisement record management unit 1006 updates data of the number of expressions associated with the searched knowledge advertisement data, and records the updated data of the number of expressions in the advertisement record.

The fee computing unit 1007 computes a second fee for charging the advertiser, by using the data of the number of expressions.

Furthermore, according to another embodiment of the present invention, the advertisement record is registered by categories, and the online advertising system 1000 provides an interface enabling the user to select a category. The input unit 1003 receives a selection of category from the user, and the search unit 1004 searches for an advertisement record corresponding to the selected category and searches for knowledge advertisement data included in the searched advertisement record. The output unit 1005 generates a search result list with respect to the searched knowledge advertisement data, and provides the user with the generated search result list.

Furthermore, according to another embodiment of the present invention, the online advertising system 1000 controls a third fee with respect to providing of the knowledge advertisement data to be charged the advertiser. The input unit 1003 receives a request for selecting search results with respect to knowledge advertisement data among the search result list, from the user who has been provided with the search result list. At the request, the output unit 1005 provides the user with knowledge advertisement data associated with the search results, by displaying the same.

In case that the knowledge advertisement data is provided for the user, the advertisement record management unit 1006 updates the data of the number of selections and records the same in the advertisement record. The fee computing unit 1007 computes a third fee for charging the advertiser with respect to providing of the knowledge advertisement data, based on the data of the number of selections.

Furthermore, according to another embodiment of the present invention, in case that a link to a predetermined web page is provided for the user, the online advertising system 1000 controls a predetermined fourth fee to be charged the advertiser with respect to access to the web page. According to the present embodiment, advertisement data included in the knowledge advertisement data has data for providing a link to a predetermined web page (e.g., a web page for selling goods of the advertiser, a bulletin board for inquiries related to goods, a bulletin board for post-purchases, etc). The user may ask the online advertising system 1000 of access to the web page by selecting the link. The advertisement record management unit 1006 updates the data of the number of link selections and records the same in the advertisement record. The fee computing unit 1007 computes a fourth fee for charging the advertiser with respect to providing of the link, by using the data of the number of link selections.

In case that the first fee, the second fee, the third fee, or the fourth fee, as aforementioned, is computed, the online advertising system 1000 notifies a predetermined billing system of billing particulars related to the first, the second, the third, or the fourth fee, and controls the advertiser to be charged.

The embodiments of the present invention include computer readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts.

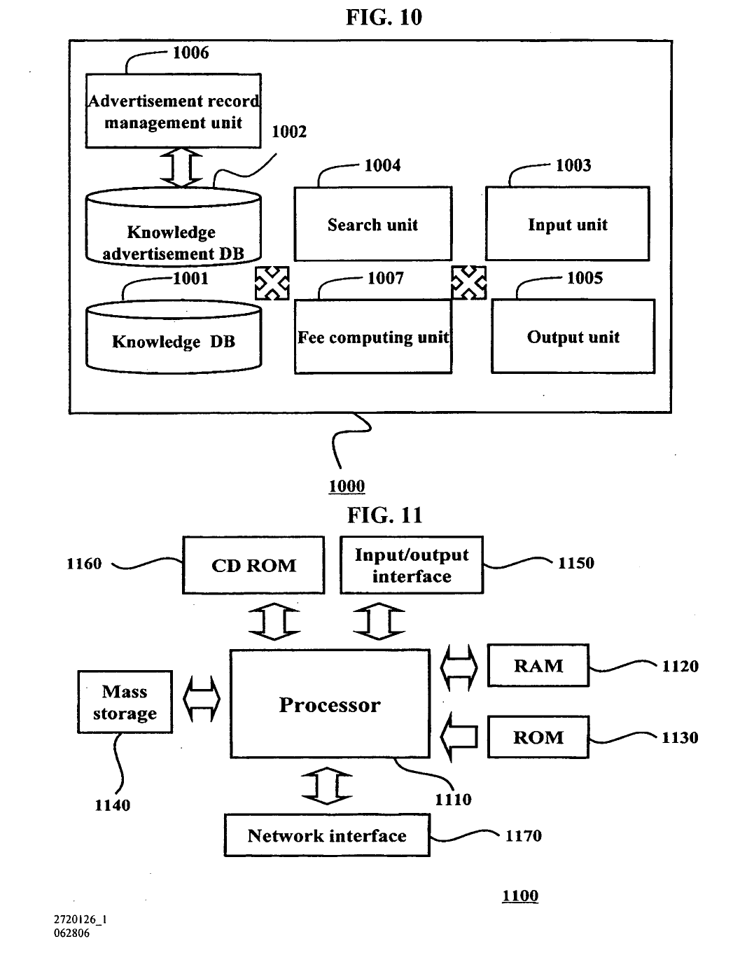

FIG. 11 is an internal block diagram of a general-purpose computer which can be adopted in implementing the online advertising method according to the present invention.

The computer system 1100 includes any number of processors 1110 (also referred to as central processing units, or CPUs) that are coupled to storage devices including primary storage (typically a random access memory, or “RAM 1120”), primary storage (typically a read only memory, or “ROM 1130”). As is well known in the art, ROM 1130 acts to transfer data and instructions uni-directionally to the CPU and RAM 1120 is used typically to transfer data and instructions in a bi-directional manner. Both of these primary storage devices may include any suitable type of the computer-readable media described above. A mass storage device 1140 is also coupled bi-directionally to CPU and provides additional data storage capacity and may include any of the computer-readable media described above. The mass storage device 1140 may be used to store programs, data and the like and is typically a secondary storage medium such as a hard disk that is slower than primary storage. A specific mass storage device such as a CD-ROM 1160 may also pass data uni-directionally to the CPU. Processor 1110 is also coupled to an interface 1150 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, processor 1110 optionally may be coupled to a computer or telecommunications network using a network connection as shown generally at network interface 1170. With such a network connection, it is contemplated that the CPU might receive information from the network, or might output information to the network in the course of performing the above-described method steps. The above-described devices and materials will be familiar to those of skill in the computer hardware and software arts.

The hardware elements above may be configured to act as one or more software modules for implementing the operations of this invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching.

Therefore, it is intended that the scope of the invention be defined by the claims appended thereto and their equivalents.

Although the present invention has been described in connection with the embodiment of the present invention illustrated in the accompanying drawings, it is not limited thereto since it will be apparent to those skilled in the art that various substitutions, modifications and changes may be made thereto without departing from the scope and spirit of the invention.

### INDUSTRIAL APPLICABILITY

The present invention provides an online advertising method and an online advertising system which enable an advertisement by including advertisement data in knowledge data provided for users and providing the same for users.

Furthermore, the present invention provides an online advertising method and an online advertising system which enable an advertisement targeting a user who has interest in a filed related to a keyword, by including advertisement data associated with the keyword in knowledge advertisement data including the predetermined keyword, e.g. a keyword input by the user, and providing a user with the knowledge advertisement data.

Furthermore, the present invention provides an online advertising method and an online advertising system, which enable a targeting advertisement by providing a user with knowledge advertisement data through a category search method, i.e. by providing a user with knowledge advertisement data associated with a category corresponding to a field in which the user is interested.

Furthermore, the present invention provides an online advertising method and an online advertising system, which enable at least one charge during a variety of procedures while charging an advertiser in a procedure of registering knowledge advertisement data including the advertisement data, i.e. enabling the advertiser to be charged respectively in a procedure in which the knowledge advertisement data is expressed as a search result, a procedure in which the knowledge advertisement data is selected by the user and provided, a procedure in which the user gets access to a predetermined web page by using a link included in the knowledge advertisement data, or a procedure in which the user purchases predetermined goods by getting access to the web page.

Furthermore, the present invention provides an online advertising method and an online advertising system, which enable an advertiser to select various levels of advertisement data display methods and enable the advertiser to be charged differently based on the levels.

What is claimed is:

1. A method for online advertising, the method comprising:
maintaining knowledge data in a knowledge database, wherein the knowledge data includes question data and associated answer data;
receiving from an advertiser answer data and advertisement data associated with question data that has been registered in the knowledge database;
generating knowledge advertisement data by using the question data, the answer data, and/or the advertisement data;
receiving a keyword from a user through a communication network;
searching the knowledge database for knowledge data that includes the keyword;
searching the knowledge database for knowledge advertisement data that includes the keyword;
generating a search result list using the searched knowledge data and/or the searched knowledge advertisement data; and
providing the user with the generated search result list.

2. The method of claim 1, further comprising authorizing an advertiser to register knowledge advertisement data associated with question data including a keyword.

3. The method of claim 2, wherein authorizing an advertiser to register knowledge advertisement data associated with question data including a keyword, comprises:
auctioning authority to an advertiser for registration of knowledge advertisement data associated with question data including a keyword; and
determining fees for the auctioned registration authority.

4. The method of claim 1, wherein the advertisement data is received from an advertiser who has been given the authority for registration of the advertisement data associated with the keyword.

5. The method of claim 1, further comprising controlling fees charged to the advertiser for the authority of registration.

6. The method of claim 1, further comprising storing an advertisement record in the knowledge advertisement database.

7. The method of claim 6, wherein the advertisement record comprises generated knowledge advertisement data, an advertiser identifier for identifying the advertiser, and/or data of the number of expressions associated with the knowledge advertisement data.

8. The method of claim 7, further comprising recording in the advertisement record data on the number of expressions associated with the searched knowledge advertisement data.

9. The method of claim 6, wherein storing the advertisement record in the knowledge advertisement database comprises:
giving authority to an advertiser for registration of knowledge advertisement data associated with question data including a keyword;
controlling fees charged to the advertiser for the authority of registration;
receiving from the advertiser question data, advertisement data and answer data;
generating knowledge advertisement data by using the question data, the answer data, and the advertisement data;
generating an advertisement record including the generated knowledge advertisement data and/or an advertiser identifier for identifying the advertiser; and
registering the generated advertisement record in the knowledge advertisement database.

10. The method of claim 9, wherein giving authority to an advertiser for registration of knowledge advertisement data associated with question data including a keyword comprises:
auctioning authority to an advertiser for registration of knowledge advertisement data associated with question data including a keyword; and
determining fees for the auctioned registration authority.

11. The method of claim 6, further comprising controlling the advertiser to be charged by using data from the advertisement record.

12. The method of claim 11, wherein the data used from the advertisement record is data of the number of expressions associated with the knowledge advertisement data.

13. The method of claim 6, wherein storing the advertisement record in the knowledge advertisement database comprises:
maintaining fee data by display method in a fee database;
receiving a selection of a display method from the advertiser;
recording data in the advertisement record on the selected display method for the knowledge advertisement data;
searching the fee database for fee data corresponding to the selected display method; and
controlling the fee charged to the advertiser using the searched fee data; and
wherein generating a search result list with respect to the searched knowledge advertisement data and providing the user with the generated search result list comprises:
displaying the search result list according to the selected display method.

14. The method of claim 6, wherein said step of storing the advertisement record in the knowledge advertisement database comprises:
maintaining fee data by display method in a fee database;
receiving a selection of a display method from the advertiser;
recording data in the advertisement record on the selected display method for the knowledge advertisement data;
searching the fee database for fee data corresponding to the selected display method;
controlling the fee charged to the advertiser using the searched fee data;
receiving from the user a selection of knowledge advertisement data from the search result list; and
displaying the selected knowledge advertisement data according to the selected display method.

15. The method of claim 6, wherein the advertisement record further comprises data of the number of selections of knowledge advertisement data; and the method further comprises:
receiving from the user a selection of knowledge advertisement data from the search result list;
providing the user with the selected knowledge advertisement data;
recording data on the number of selections of the advertisement data; and
controlling fees charged to the advertiser using the number of selections of the advertisement data.

16. The method of claim 1, wherein the advertisement data comprises a web page associated with the advertiser, data for providing a link to a bulletin board for inquiries or to a bulletin board for post-purchases, and/or advertisement copy data and image data with respect to an advertisement object.

17. The method of claim 1, wherein the advertisement record further comprises data of the number of link selections associated with the knowledge advertisement data, and the advertisement data includes data for providing a link to a web page; and the method further comprising:
receiving from the user a selection of knowledge advertisement data from the search result list;
providing the user with the selected knowledge advertisement data;
receiving a selected link to a web page from the user;
recording data in the advertisement record on the number of link selections; and
controlling fees charged to the advertiser using the number of link selections.

18. The method of claim 1, wherein the advertisement record further includes data on the number of goods purchased and the advertisement data includes data for providing a link to a web page: and the method further comprising:
receiving from the user a selection of knowledge advertisement data from the search result list;
providing the user with the selected knowledge advertisement data;
receiving a selected link to a web page from the user;
receiving a notification of a purchase from a web server associated with the web page if the user purchases goods through the web page;
recording data in the advertisement record on the number of goods purchased; and
controlling fees charged to the advertiser using the data on the number of goods purchased.

19. The method of claim 1, wherein the knowledge advertisement data further includes opinion data that is input from a user; and the method further comprises:
providing the advertiser with the opinion data; and
deleting the opinion data from the knowledge advertisement data if a request for deletion of the opinion data is received from the advertiser.

20. A method for online advertising, the method comprising:
receiving from an advertiser answer data and advertisement data associated with question data that has been registered in the knowledge database;
generating knowledge advertisement data by using the knowledge data, the answer data or the advertisement data;
storing an advertisement record by category in the knowledge advertisement database;
receiving a selection of a category from a user;
searching the knowledge advertisement database for an advertisement record corresponding to the user's selected category;
searching the knowledge advertisement database for knowledge advertisement data corresponding to the user's selected category;
generating a search result list using the searched knowledge advertisement data; and
providing the user with the generated search result list;

21. The method of claim 20, further comprising:
recording in the advertisement record data on the number of expressions associated with the searched knowledge advertisement data; and
controlling the advertiser to be charged by using the data of the number of expressions associated with the knowledge advertisement data.

22. The method of claim 20, further comprising authorizing an advertiser to register knowledge advertisement data associated with question data including a keyword.

23. The method of claim 22, wherein authorizing an advertiser to register knowledge advertisement data associated with question data including a keyword comprises:
auctioning authority for registration of knowledge advertisement data associated with question data including a keyword to an advertiser; and
determining fees for the auctioned registration authority.

24. The method of claim 20, further comprising controlling fees charged to the advertiser for the authority of registration.

25. The method of claim 20, the answer data and advertisement data is received from an advertiser who has been given the authority for registration of answer data and advertisement data associated with the keyword.

26. The method of claim 20, wherein the advertisement record comprises generated knowledge advertisement data, an advertiser identifier for identifying the advertiser, and/or data of the number of expressions associated with the knowledge advertisement data.

27. The method of claim 20, wherein the advertisement data comprises a web page associated with the advertiser, data for providing a link to a bulletin board for inquiries or to a bulletin board for post-purchases, advertisement copy data, and/or image data with respect to an advertisement object.

28. The method of claim 20, wherein storing an advertisement record by category in the knowledge advertisement database comprises:
authorizing an advertiser to register knowledge advertisement data associated with question data including a keyword;
controlling fees charged to the advertiser for the authority of registration;
receiving from the advertiser question data, advertisement data and answer data including the keyword;
generating knowledge advertisement data by using the question data, the answer data, and the advertisement data; and
generating an advertisement record including the generated knowledge advertisement data and/or an advertiser identifier for identifying the advertiser; and
registering the generated advertisement record in the knowledge advertisement database.

29. The method of claim 20, wherein the advertisement record further includes data of the number of selections of knowledge advertisement data; and the method further comprises:
receiving from the user a selection of knowledge advertisement data from the search result list;
providing the user with the selected knowledge advertisement data;
recording data on the number of selections of the advertisement data; and
controlling fees charged to the advertiser using the number of selections of the advertisement data.

30. The method of claim 20, wherein the advertisement record further comprises data of the number of link selections associated with the knowledge advertisement data, and the advertisement data includes data for providing a link to a web page, and the method further comprising:
receiving from the user a selection of knowledge advertisement data from the search result list;
providing the user with the selected knowledge advertisement data;
receiving a selected link to a web page from the user;
recording data in the advertisement record on the number of link selections; and
controlling fees charged to the advertiser using the number of link selections.

31. The method of claim 20, wherein the advertisement record further includes data on the number of goods purchased and the advertisement data includes data for providing a link to a web page, and the method further comprising:
receiving from the user a selection of knowledge advertisement data from the search result list;
providing the user with the selected knowledge advertisement data;
receiving a selected link to a web page from the user;
receiving a notification of a purchase from a web server associated with the web page if the user purchases goods through the web page;
recording data in the advertisement record on the number of goods purchased; and
controlling fees charged to the advertiser using the data on the number of goods purchased.

32. The method of claim 1, wherein storing the advertisement record in the knowledge advertisement database comprises:
maintaining fee data by display method in a fee database;
receiving a selection of a display method from the advertiser;
recording data in the advertisement record on the selected display method for the knowledge advertisement data;
searching the fee database for fee data corresponding to the selected display method; and
controlling the fee charged to the advertiser using the searched fee data; and
wherein generating a search result list with respect to the searched knowledge advertisement data and providing the user with the generated search result list comprises:
displaying the search result list according to the selected display method.

33. The method of claim 20, wherein said step of storing the advertisement record in the knowledge advertisement database comprises:
maintaining fee data by display method in a fee database;
receiving a selection of a display method from the advertiser;
recording data in the advertisement record on the selected display method for the knowledge advertisement data;
searching the fee database for fee data corresponding to the selected display method;
controlling the fee charged to the advertiser using the searched fee data;
receiving from the user a selection of knowledge advertisement data from the search result list; and
displaying the selected knowledge advertisement data according to the selected display method.

34. The method of claim 20, wherein the knowledge advertisement data further includes opinion data that is input from a user; and the method further comprises:
providing the advertiser with the opinion data; and
deleting the opinion data from the knowledge advertisement data if a request for deletion of the opinion data is received from the advertiser.

35. A computer-readable medium storing instructions when executed perform a method comprising:
maintaining knowledge data in a knowledge database, wherein the knowledge data includes question data and associated answer data;
receiving from an advertiser answer data and advertisement data associated with question data that has been registered in the knowledge database;
generating knowledge advertisement data by using the question data, the answer data, and/or the advertisement data;
receiving a keyword from a user through a communication network;
searching the knowledge database for knowledge data that includes the keyword;
searching the knowledge database for knowledge advertisement data that includes the keyword;
generating a search result list using the searched knowledge data and/or the searched knowledge advertisement data; and
providing the user with the generated search result list.

36. The computer-readable medium of claim 34, further comprising giving authority to an advertiser for registration of knowledge advertisement data associated with question data including a keyword.

37. The computer-readable medium of claim 35, wherein the advertisement data is received from an advertiser who has been given the authority for registration of the advertisement data associated with the keyword.

38. The computer-readable medium of claim 34, further comprising controlling fees charged to the advertiser for the authority of registration.

39. The computer-readable medium of claim 34, further comprising storing an advertisement record in the knowledge advertisement database.

40. The computer-readable medium of claim 38, wherein the advertisement record comprises generated knowledge advertisement data, an advertiser identifier for identifying the advertiser, and/or data of the number of expressions associated with the knowledge advertisement data.

41. The computer-readable medium of claim 38, further comprising recording in the advertisement record data on the number of expressions associated with the searched knowledge advertisement data.

42. The computer-readable medium of claim 38, further comprising controlling the advertiser to be charged by using data from the advertisement record.

43. The computer-readable medium of claim 41, wherein the data used from the advertisement record is data of the number of expressions associated with the knowledge advertisement data.

44. A system for online advertising, the system comprising:
a knowledge database for maintaining knowledge data, wherein the knowledge data includes question data and associated answer data;
answer data and advertisement data received from an advertiser for the question data in the knowledge database;
knowledge advertisement data generated by using the question data, the answer data and/or the advertisement data;
a knowledge advertisement database for storing at least one advertisement record;
an input unit configured for receiving a keyword from a user through a communication network;
a search unit configured for searching the knowledge database for knowledge data that includes the keyword and searching the knowledge advertisement database for knowledge advertisement data that includes the keyword; and
an output unit configured for generating a search result list with respect to the searched knowledge data and/or the searched knowledge advertisement data, and providing the user with the generated search result list.

45. The system of claim 43, wherein the answer data and advertisement data is associated with a keyword and is received from an advertiser who has been given the authority for registering the data.

46. The system of claim 43, the system further comprising:
an advertisement record management unit configured for recording in the advertisement record data on the number of expressions associated with the searched knowledge advertisement data; and
a fee computing unit configured for computing a second fee for charging the advertiser by using the data of the number of expressions associated with the knowledge advertisement data.

47. The system of claim 43, wherein the knowledge advertisement database comprises:
knowledge advertisement data associated with question data including a keyword registered by an authorized advertiser;
fees charged to the advertiser are adjusted according to the authorized registration of the advertiser;

48. The system of claim 43, wherein the advertisement record comprises generated knowledge advertisement data, an advertiser identifier for identifying the advertiser, and/or data of the number of expressions association with the knowledge advertisement data.

49. The system of claim 43, wherein the advertisement data and/or the advertisement record is maintained by category; and wherein the search unit is configured to search for knowledge data and/or knowledge advertisement data in a category searching method.

50. The system of claim 43, wherein the fee computing unit is configured to compute a first fee with respect to registration of the advertisement record on the basis of a registration period of the advertisement record, and/or the number of expressions of knowledge advertisement data that is included in the advertisement record.

51. The system of claim 43, wherein:
the advertisement record further includes data of the number of selections of knowledge advertisement data;
the input unit is configured to receive from the user selected knowledge advertisement data from the search result list;
the output unit configured to provide the user with the selected knowledge advertisement data;
the advertisement record management unit configured to record in the advertisement record data of the number of selections of knowledge advertisement data; and
the fee computing unit configured to compute a third fee for charging the advertiser by using the data of the number of selections of the knowledge advertisement data.

52. The system of claim 43, wherein:
the advertisement record further includes data of the number of link selections associated with the knowledge advertisement data;
the advertisement data further includes data for offering a link to a web page;
the input unit is configured to receive from the user a selection of a link to the web page;
the advertisement record management unit is configured to record the data of the number of link selections associated with the knowledge advertisement data;
the fee computing unit is configured to compute a fourth fee for charging the advertiser by using the data of the number of link selections associated with the knowledge advertisement data; and
the online advertisement system is configured to retrieve the web page to a terminal of the user.

53. A computer readable medium storing instructions when executed perform a method comprising:
authorizing an advertiser to register knowledge advertisement data associated with question data including a keyword;
controlling fees to be charged to the advertiser for the authority of registration;
receiving from an advertiser answer data and advertisement data associated with question data that has been registered in the knowledge database and includes the keyword, wherein the advertiser has been given the authority for registration associated with the keyword;
generating knowledge advertisement data by using the knowledge data, the answer data, and/or the advertisement data;
storing an advertisement record by category in the knowledge advertisement database, wherein the advertisement record comprises generated knowledge advertisement data, an advertiser identifier for identifying the advertiser, and/or data of the number of expressions associated with the knowledge advertisement data;
receiving a selection of a category from a user;
searching the knowledge advertisement database for an advertisement record corresponding to the user's selected category;
searching the knowledge advertisement database for knowledge advertisement data corresponding to the user's selected category;
generating a search result list using the searched knowledge advertisement data;
providing the user with the generated search result list;
recording in the advertisement record data on the number of expressions associated with the searched knowledge advertisement data; and
controlling the advertiser to be charged by using the data of the number of expressions associated with the searched knowledge advertisement data.

54. A method for online advertising, the method comprising:
receiving from an advertiser answer data and advertisement data associated with question data, wherein the question data and associated answer data and associated advertisement data comprise knowledge data;
generating knowledge advertisement data by using the question data, the answer data, and/or the advertisement data;
receiving a keyword from a user; and
providing the user with knowledge data and/or the knowledge advertisement data that includes the keyword.

55. A system for online advertising, the system comprising:
answer data and advertisement data received from an advertiser for question data, wherein the question data and associated answer data and associated advertisement data comprise knowledge data;
knowledge advertisement data generated by using the question data, the answer data and/or the advertisement data;
an input unit configured for receiving a keyword from a user;
a processing unit configured for providing the user with knowledge data and/or knowledge advertisement data that includes the keyword.

56. A system for online advertising, the system comprising:
means for receiving from an advertiser answer data and advertisement data associated with question data, wherein the question data and associated answer data and associated advertisement data comprise knowledge data;
means for generating knowledge advertisement data by using the question data, the answer data, and/or the advertisement data;
means for receiving a keyword from a user; and
means for providing the user with knowledge data and/or the knowledge advertisement data that includes the keyword.
